(19) United States
(12) Patent Application Publication
(10) Pub. No.: US 2025/0183467 A1
(43) Pub. Date: Jun. 5, 2025

(54) BATTERY

(71) Applicant: MURATA MANUFACTURING CO., LTD., Kyoto (JP)

(72) Inventors: Kensuke FUJIWARA, Kyoto (JP); Yoshiichi HORIKOSHI, Kyoto (JP); Daiki NISHIIE, Kyoto (JP); Yasuhiro MATSUZAKI, Kyoto (JP)

(21) Appl. No.: 18/924,354

(22) Filed: Oct. 23, 2024

(30) Foreign Application Priority Data
Nov. 30, 2023 (JP) 2023-202631

(51) Int. Cl. H01M 50/342; H01M 50/107; H01M 50/581

(52) U.S. Cl. CPC H01M 50/3425; H01M 50/107; H01M 50/581; H01M 2200/10

(57) ABSTRACT

Provided is a battery further superior in safety. A battery that is a cylindrical battery including a cylindrical exterior body that houses a battery element, and safety valves disposed at both end portions of the exterior body, wherein each of the safety valves includes: a first metal member; a support portion that is provided to support the first metal member at a peripheral edge portion of the first metal member and has an opening; and a first insulating member that connects the first metal member and the support portion and contains a thermoplastic resin.

### CROSS REFERENCE TO RELATED APPLICATIONS

The present application claims priority to Japanese patent application no. 2023-202631, filed on Nov. 30, 2023, the entire contents of which is incorporated by reference.

### BACKGROUND

The present disclosure relates to a battery, and particularly a cylindrical battery.

Batteries are capable of extracting energy due to chemical change or the like as electric energy, and used for various applications. For example, batteries are used in mobile devices such as mobile phones, smart phones, and notebook computers.

Conventionally, as such a battery, for example, there is a battery described in a metal can of this battery is characterized by including a side wall (cylindrical tube) that is used as an electrochemical battery cell container and defines first and second opening end portions, a first metal end cap (positive electrode end gap) that is disposed at the first opening end portion of the side wall and has an inner surface and an outer surface, a terminal plate (nickel interface terminal) soldered to the outer surface of the first end cap, and a second metal plate that is disposed at the second opening end portion of the side wall.

### SUMMARY

There is room for improvement in safety in the battery, for example, as described above.

In an embodiment, the present disclosure relates to providing a battery having further improved safety.

The present inventors have conducted intensive studies to solve the above problems, and have arrived at the present disclosure, for example, in which by the inclusion of a heat release mechanism at both end portions of a battery in order to sufficiently inhibit a rapid increase in internal pressure of the battery in an abnormally high temperature state, the rapid increase in internal pressure of the battery in the abnormally high temperature state is sufficiently inhibited and the safety is thereby further improved. That is, the present disclosure includes the following according to an embodiment.

A battery according to an embodiment of the present disclosure is a cylindrical battery including: a cylindrical exterior body that houses a battery element; and safety valves disposed at both end portions of the exterior body, in which the safety valve includes: a first metal member; a support portion that is provided to support the first metal member at a peripheral edge of the first metal member and has an opening; and a first insulating member that connects the first metal member and the support portion and contains a thermoplastic resin.

The battery of an embodiment of the present disclosure is further superior in safety.

### BRIEF DESCRIPTION OF THE FIGURES

FIG. 1 is a side view schematically illustrating a battery according to an embodiment of the present disclosure;

FIG. 2 is an enlarged sectional view of a part A in FIG. 1;

FIG. 3 is an enlarged sectional view of a part B in FIG. 1;

FIG. 4 is a sectional view (in a normal state) schematically illustrating an end portion of a battery according to an embodiment of the present disclosure;

FIG. 5 is an exploded perspective view schematically illustrating an end portion of a battery according to an embodiment of the present disclosure;

FIG. 6 is a sectional view (in an abnormally high temperature state) schematically illustrating an end portion of a battery according to an embodiment of the present disclosure;

FIG. 7 is a plan view schematically illustrating the end portion on the lower portion side of a comparative example; and

FIG. 8 is a diagram schematically showing a change with time in internal pressure in batteries of Examples and Comparative Examples.

### DETAILED DESCRIPTION

Hereinafter, the present disclosure will be described in further detail according to an embodiment. It should be noted that the applicant provides the following description and examples for those skilled in the art to fully understand the present disclosure, and these are not intended to limit the claimed subject matter. That is, the present disclosure is not particularly limited to the preferred embodiments and the like described below, and can be appropriately modified within the scope of the object. Note that, in consideration of the description of the main points or ease of understanding, the present invention may be explained by being divided into embodiments, examples, and the like, for convenience, but partial replacement and/or combination of configurations illustrated in different embodiments and the like are possible. In the description of such an embodiment, redundant description of substantially the same matters may be omitted, and only different points may be described. In particular, similar functions and effects made by similar configurations are sometimes not be sequentially mentioned for each embodiment.

Furthermore, in the description in the present specification, reference to a direction, an orientation, or the like is merely for convenience of description, and is not intended to limit the scope of the present disclosure unless otherwise explicitly described. For example, relative terms such as “Outer (or outer side, outer part, or outer peripheral)” and “Inner (or inner side, inner part, or inner peripheral)” and derived terms thereof should be understood to refer to directions described or illustrated. Similarly, “on” an element includes not only a case of being in contact with the upper surface of the element but also a case of not being in contact with the upper surface of the element. That is, “on” an element includes not only an upper position away from the element, that is, an upper position via another object on the element or an upper position spaced apart from the element, but also an immediately above position in contact with the element. In addition, the term “on” does not necessarily mean the upper side in the vertical direction. The term “on” merely indicates a relative positional relationship of certain elements. That is, unless otherwise explicitly described, the invention is not limited only to a specific direction, orientation, form, or the like. In addition, the same applies to terms such as “provided”, “disposed”, and “connected”, and derived terms thereof. Unless otherwise explicitly described, the terms are not limited to a direct mode, and may be a mode in which another element such as an intervening object is interposed.

The various numerical ranges mentioned in the present specification are intended to include the lower and upper limit numerical values themselves unless otherwise specified, for example, by “less than”. That is, taking a numerical range such as 700 to 740° C. as an example, it is interpreted as including both the lower limit value “700° C.” and the upper limit value “740° C.”.

The “battery” as used herein includes not only a so-called “secondary battery” but also a “primary battery” capable of only discharging. That is, the “battery” in the present specification may be a “secondary battery”, which can be repeatedly charged and discharged, or a “primary battery”, which is substantially only discharged. The “secondary battery” is not excessively limited by its name, and for example, “power storage devices” and the like can also be included in the subject.

Hereinafter, for convenience of description, the battery of the present disclosure will be described mainly by taking a secondary battery as an example.

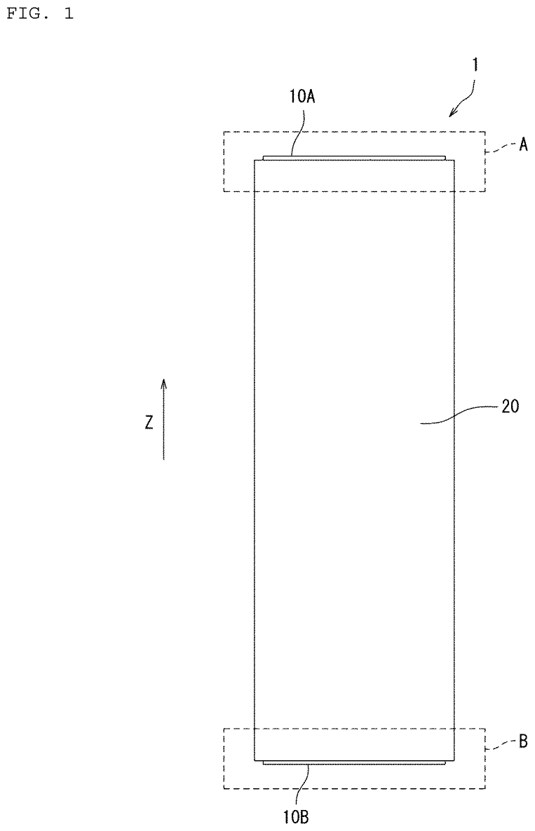

The secondary battery according to the present disclosure includes a battery assembly (electronic device) composed of an electrode-constituting layer including a positive electrode, a negative electrode, and a separator. In the secondary battery according to the present disclosure, the battery assembly may have a wound structure (hereinafter, also referred to as “wound electrode body” or “wound structure body”) in which such an electrode-constituting layer is wound in a roll shape. FIG. 1 schematically illustrates an exemplary embodiment of an appearance of a secondary battery 1. FIG. 1 is a side view schematically illustrating a battery according to one embodiment of the present disclosure. As illustrated in FIG. 1, a battery assembly (not shown) is housed inside an exterior body 20. The battery assembly has a configuration in which the positive electrode, the negative electrode, and the separator disposed between the positive electrode and the negative electrode are wound. In the secondary battery 1, such a battery assembly is sealed in the exterior body 20 together with an electrolyte (for example, a non-aqueous electrolyte).

The positive electrode includes at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for each of a plurality of positive electrodes in the battery assembly, the positive electrode material layer may be provided on both surfaces of the positive electrode current collector, or may be provided only on one surface of the positive electrode current collector.

The negative electrode includes at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for each of a plurality of negative electrodes in the battery assembly, the negative electrode material layer may be provided on both surfaces of the negative electrode current collector, or may be provided only on one surface of the negative electrode current collector.

The electrode active materials included in the positive electrode and the negative electrode, that is, the positive electrode active material and the negative electrode active material are substances directly involved in the transfer of electrons in the secondary battery, and are main substances of the positive and negative electrodes, which are responsible for charging and discharging, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. That is, the secondary battery according to the present invention may be a non-aqueous electrolyte secondary battery in which lithium ions move between the positive electrode and the negative electrode through a non-aqueous electrolyte, whereby charging and discharging of the battery is performed. When lithium ions are involved in charging and discharging, the secondary battery according to the present invention corresponds to a so-called “lithium ion battery”, and the secondary battery includes layers capable of occluding and releasing lithium ions as the positive electrode and the negative electrode.

In view of a lithium ion battery, the positive electrode active material may be a material that contributes to occlusion and release of lithium ions. That is, the positive electrode layer may contain any one kind or two or more kinds among positive electrode materials capable of occluding and releasing lithium. From such a viewpoint, the positive electrode active material may be, for example, a lithium-containing compound. The lithium-containing compound is not particularly limited in its type, but may be, for example, a lithium-containing composite oxide, a lithium-containing phosphate compound, or the like. This is because a high energy density can be easily obtained.

The lithium-containing composite oxide is a generic name of oxides containing lithium and one or two or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that contain lithium and one or two or more of other elements as constituent elements, and may have, for example, a crystal structure such as an olivine type crystal structure. The kind of the other elements is not particularly limited as long as the element is any one or two or more of arbitrary elements. Among them, as the other elements, one or two or more of elements belonging to Groups 2 to 15 in the long-period periodic table is preferable. More specific examples of the other elements include nickel (Ni), cobalt (Co), manganese (Mn) and iron (Fe). This is because a high voltage is likely to be obtained by these additive elements.

Examples of the lithium-containing composite oxide having a layered rock-salt type crystal structure include compounds each represented by the following formulae (1) to (3).

LiₐMn_{(1-b-c)}NibM11_{c}O₍₂₋ₐ₎Fₑ (1)

(In the formula (1), M11 is at least one element among cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); a to e satisfy 0.8≤a≤1.2, 0<b<0.5, 0≤c≤0.5, (b+c)<1, −0.1≤d≤0.2, and 0≤e≤0.1, provided that the composition of lithium varies depending on the charged and discharged states, and a is a value of a fully discharged state.)

LiₐNi_{(1-b)}M12_{b}O_{(2-c)}F_{d} (2)

(In the formula (2), M12 is at least one element among cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤1.2, 0.005≤b≤0.5, −0.1≤c≤0.2, and 0≤d≤0.1, provided that the composition of lithium varies depending on the charged and discharged states, and a is a value of a fully discharged state.)

LiₐCo_{(1-b)}M13_{b}O_{(2-c)}F_{d} (3)

(In the formula (3), M13 is at least one element among nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤1.2, 0≤b<0.5, −0.1≤c≤0.2, and 0≤d≤0.1, provided that the composition of lithium varies depending on the charged and discharged states, and a is a value of a fully discharged state.)

Specific examples of the lithium-containing composite oxide having a layered rock-salt type crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂.

When the lithium-containing composite oxide having a layered rock-salt type crystal structure contains nickel, cobalt, manganese, and aluminum as constituent elements, the atomic ratio of nickel is preferably 50 atomic % or more. This is because a high energy density can be easily obtained.

Examples of the lithium-containing composite oxide having a spinel type crystal structure include a compound represented by the following formula (4).

LiₐMn_{(2-b)}M14_{b}O_{c}F_{d} (4)

(In the formula (4), M14 is at least one element among cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.9≤a≤1.1, 0≤b≤0.6, 3.7≤c≤4.1, and 0≤d≤0.1, provided that the composition of lithium varies depending on the charged and discharged states, and a is a value of a fully discharged state.)

Specific examples of the lithium-containing composite oxide having a spinel type crystal structure include LiMn₂O₄.

Examples of the lithium-containing phosphate compound having an olivine type crystal structure include a compound represented by the following formula (5).

LiₐM15PO₄ (5)

(In the formula (5), M15 is at least one element among cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); a satisfies 0.9≤a≤1.1, provided that the composition of lithium varies depending on the charged and discharged states, and a is a value of a fully discharged state.)

Specific examples of the lithium-containing phosphate compound having an olivine type crystal structure include LiFePO₄, LiMnPO₄, LiFe_{0.5}Mn_{0.5}PO₄, and LiFe_{0.3}Mn_{0.7}PO₄.

Incidentally, the lithium-containing composite oxide may be a compound represented by the following formula (6).

(Li₂MnO₃)ₓ(LiMnO₂)₁₋ₓ (6)

(In the formula (6), x satisfies 0≤x≤1, provided that the composition of lithium varies depending on the charged and discharged states, and x is a value of a fully discharged state.)

In addition, for example, the positive electrode material may be any one kind or two or more kinds among oxides, disulfides, chalcogenides, and conductive polymers. Examples of the oxide include titanium oxide, vanadium oxide, and manganese dioxide. Examples of the disulfide include titanium disulfide and molybdenum sulfide. The chalcogenide is, for example, niobium selenide or the like. The conductive polymer may be, for example, sulfur, polyaniline, polythiophene, or the like. However, the positive electrode material is not particularly limited, and may be a material other than the above materials.

The positive electrode material layer may contain a binder. A positive electrode conductive agent may also be contained in the positive electrode material layer to facilitate the transfer of electrons promoting the battery reaction. The binder of the positive electrode may contain, for example, any one of, or two or more of synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductive agent includes, for example, any one or two or more of carbon materials. The carbon material may be, for example, graphite, carbon black, acetylene black, ketjen black, or the like. However, the positive electrode conductive agent may be a metal material, a conductive polymer, and the like, as long as it is a material exhibiting conductivity.

Similarly, the negative electrode active material of the negative electrode material layer may be a material that contributes to occlusion and release of lithium ions. That is, the negative electrode layer may contain any one kind or two or more kinds among negative electrode materials capable of occluding and releasing lithium. From such a viewpoint, the negative electrode active material may be, for example, various carbon materials, metal-based materials, and/or other materials.

When the carbon material is used as the negative electrode active material, the crystal structure shows a very small change when lithium is occluded and when lithium is released, so that a high energy density can be easily and stably obtained. Further, the carbon material also functions as a negative electrode conductive agent, so that the negative electrode layer easily has an improved conductivity.

Specific examples of the carbon material include graphitizable carbon, non-graphitizable carbon, and/or graphite. More specifically, the carbon material may be, for example, pyrolytic carbons, cokes, glassy carbon fiber, organic polymer compound fired body, activated carbon, carbon blacks, or the like. The cokes may include pitch coke, needle coke, and petroleum coke. The organic polymer compound fired body is, for example, a material obtained by firing (carbonizing) a polymer compound such as phenol resin and furan resin at an appropriate temperature. In addition, the carbon material may be low crystalline carbon subjected to a heat treatment at a temperature of about 1000° C. or less, or may be amorphous carbon. The shape of the carbon material is not particularly limited, and may be at least one of a fibrous shape, a spherical shape, a granular shape, and a scaly shape.

The “metal-based material” used as the negative electrode active material is a generic name of materials containing any one kind or two or more kinds among metal elements and metalloid elements as constituent elements. When a carbon material is used as the negative electrode active material, a high energy density is likely to be obtained. The metal-based material may be a simple substance, an alloy, a compound, two or more of these, or may be a material at least a part of which has phases composed of one of, or two or more of these. However, the alloy may include a material containing one or more metal elements and one or more metalloid elements in addition to a material composed of two or more of metal elements. The alloy may also contain a non-metallic element. The construction of this metal-based material may be, for example, a solid solution, a eutectic (eutectic mixture), an intermetallic compound, and a material in which two or more kinds among these coexist. Such metal element and metalloid element may be, for example, any one of, or two or more of metal elements and metalloid elements capable of forming an alloy with lithium. Specific examples of the metal element and the metalloid element may include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium, yttrium (Y), palladium (Pd), and/or platinum (Pt). In a preferred aspect, the metal elements are silicon and tin. This is because these metal elements have excellent ability to occlude and release lithium, and a higher energy density is likely to be obtained. A material containing silicon as a constituent element may be a simple substance of silicon, an alloy of silicon, or a compound of silicon, may be two or more selected from these materials, or may be a material at least a part of which has phases composed of one of, or two or more of these. Similarly, the material containing tin as a constituent element may be a simple substance of tin, an alloy of tin, or a compound of tin, may be two or more thereof, or may be a material at least a part of which has one or two or more of these phases. The “simple substance” described here is a simple substance in a general sense to the utmost, and thus the simple substance may contain a small amount of impurities. That is, the purity of the simple substance is not necessarily limited to 100%. The alloy of silicon contains, for example, any one or two or more of tin, nickel, copper, iron, cobalt, manganese, zinc, indium, silver, titanium, germanium, bismuth, antimony, chromium, and the like as constituent elements other than silicon. The compound of silicon contains, for example, any one or two or more of carbon, oxygen, and the like as constituent elements other than silicon. The compound of silicon may contain, for example, any one or two or more of a series of elements described in the alloy of silicon as constituent elements other than silicon. Specific examples of the alloy of silicon and the compound of silicon include SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), and/or LiSiO. In SiOᵥ, “v” may be 0.2<v<1.4. The alloy of tin may contain, for example, any one or two or more types of silicon, nickel, copper, iron, cobalt, manganese, zinc, indium, silver, titanium, germanium, bismuth, antimony, chromium, and the like, as constituent elements other than tin. The compound of tin may contain, for example, any one or two or more types of carbon, oxygen, and the like, as constituent elements other than tin. The compound of tin may contain any one or two or more of a series of elements described in the alloy of tin, for example, as constituent elements other than tin. Specific examples of the alloy of tin and the compound of tin include Snow (0<w≤2), SnSiO₃, LiSnO, and/or Mg₂Sn. Particularly, the material containing tin as a constituent element may be, for example, a material containing a second constituent element and a third constituent element together with tin, which is a first constituent element (tin-containing material). The second constituent element may be, for example, any one or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, or the like. The third constituent element may be, for example, any one of, or two or more of boron, carbon, aluminum, phosphorus, or the like. This is because high battery capacity and excellent cycle characteristics are likely to be obtained by these elements. In particular, the tin-containing material may be a material (tin cobalt carbon-containing material) containing tin, cobalt, and carbon as constituent elements. This is because a high energy density is likely to be obtained by these materials. In the tin cobalt carbon-containing material, at least part of carbon which is a constituent element may be bonded to a metal element or metalloid element which is another constituent element. This is because the aggregation of tin, crystallization of tin, and the like are likely to be suppressed. Such a tin cobalt carbon-containing material is not limited to the material (SnCoC) that contains only tin, cobalt, and carbon as constituent elements. This tin cobalt carbon-containing material may further contain, for example, any one or two or more of silicon, iron, nickel, chromium, indium, niobium, germanium, titanium, molybdenum, aluminum, phosphorus, gallium, bismuth, and the like as a constituent element in addition to tin, cobalt, and carbon. In addition to the tin cobalt carbon-containing material, a material containing tin, cobalt, iron, and carbon as constituent elements (tin cobalt iron carbon-containing material) may be included.

In addition, the negative electrode material may be any one kind or two or more kinds among, for example, metal oxides and polymer compounds. Examples of the metal oxide include iron oxide, ruthenium oxide, and molybdenum oxide. Examples of the polymer compound include polyacetylene, polyaniline, and polypyrrole.

The negative electrode material layer may contain a binder. Furthermore, a negative electrode conductive agent may be included in the negative electrode material layer to facilitate the transfer of electrons promoting the battery reaction. The binder that may be contained in the negative electrode material layer is not particularly limited, but examples thereof include at least one selected from the group consisting of styrene-butadiene rubber, polyacrylic acid, polyvinylidene fluoride, polyimide-based resin, and polyamideimide-based resin. The negative electrode conductive agent that may be contained in the negative electrode material layer is not particularly limited, and examples of the negative electrode conductive agent may include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like. Note that the negative electrode material layer may contain a component derived from a thickener component (for example, a carboxymethyl cellulose) used during battery production.

The positive electrode current collector and the negative electrode current collector used for the positive electrode and the negative electrode are members configured to contribute to collecting and supplying electrons generated in the electrode active material due to the battery reaction. Such an electrode current collector may be a sheet-shaped metal member. The electrode current collector may have a single layer or multiple layers. Further, the electrode current collector may have a porous or perforated form. For example, the current collector may be a metal foil, a punching metal, a net, an expanded metal, or the like. The positive electrode current collector used for the positive electrode may include, for example, a metal foil containing at least one selected from the group consisting of aluminum, nickel, stainless steel, and the like. On the other hand, the negative electrode current collector used for the negative electrode may include, for example, a metal foil containing at least one selected from the group consisting of copper, aluminum, nickel, stainless steel, and the like.

The separator used for the positive electrode and the negative electrode is a member provided from the viewpoints of the prevention of short circuit due to contact between the positive and negative electrodes and the holding of the electrolyte and the like. In other words, the separator is a member that separates the positive electrode and the negative electrode, and allows ions (for example, lithium ions) to pass while preventing a short circuit of a current due to contact between both electrodes. For example, the separator may be a porous or microporous insulating member, which may have a film form due to its small thickness.

This separator may be, for example, any one of, or two or more of porous films of synthetic resins, ceramics and the like, and it may be a laminated film of two or more of porous films. The synthetic resin used for the separator is, for example, polytetrafluoroethylene, polypropylene, polyethylene, or the like. For example, the separator may include, a porous film (substrate layer) and a polymer compound layer provided on one side or both sides of the substrate layer. This improves the close contact of the separator to the positive electrode and may improve the close contact of the separator to the negative electrode, and thus the distortion of the wound electrode body is likely to be suppressed. The polymer compound layer may contain, for example, any one of, or two or more of polymer compounds such as polyvinylidene fluoride. This makes it easy to have excellent physical strength and to be electrochemically stable. The polymer compound layer may contain any one of, or two or more of insulation grains such as an inorganic grain. Examples of the type of inorganic grain include aluminum oxide and aluminum nitride. In the present invention, the separator is not to be particularly limited by its name, and it may be solid electrolytes, gel electrolytes, and/or insulating inorganic grains that have a similar function.

In the secondary battery according to the present disclosure, the battery assembly including the electrode-constituting layer including the positive electrode, the negative electrode, and the separator may be enclosed in the exterior body 20 together with an electrolyte. That is, the electrolyte may be a so-called “non-aqueous” electrolyte.

The electrolyte, typically, the electrolytic solution contains a solvent and an electrolyte salt. The electrolytic solution may further contain any one or two or more of other materials such as additives. In a preferred aspect, the separator may be impregnated with an electrolytic solution, and the positive electrode and/or the negative electrode may also be impregnated with an electrolytic solution.

The solvent may contain any one or two or more of non-aqueous solvents such as organic solvents. The electrolytic solution containing a non-aqueous solvent can be a so-called non-aqueous electrolytic solution. Examples of the non-aqueous solvent include a cyclic carbonate ester, a chain carbonate ester, a lactone, a chain carboxylate ester, and/or a nitrile (for example, mononitrile). This makes it easy to obtain more excellent battery capacity, cycle characteristics, and/or storage characteristics. Examples of the cyclic carbonate ester may include ethylene carbonate, propylene carbonate, and/or butylene carbonate. Examples of the chain carbonate ester include dimethyl carbonate, diethyl carbonate, ethyl methyl carbonate, and/or methyl propyl carbonate. Examples of the lactone include γ-butyrolactone and/or γ-valerolactone.

Examples of the chain carboxylate ester include methyl acetate, ethyl acetate, methyl propionate, ethyl propionate, methyl butyrate, methyl isobutyrate, methyl trimethylacetate, and/or ethyl trimethylacetate. Examples of the nitrile include acetonitrile, methoxyacetonitrile, and/or 3-methoxypropionitrile. Examples of the non-aqueous solvent include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. In particular, the non-aqueous solvent preferably contains one or two or more of ethylene carbonate, propylene carbonate, dimethyl carbonate, diethyl carbonate, ethyl methyl carbonate, and the like. This is because higher battery capacity, more excellent cycle characteristics, and/or more excellent storage characteristics can be easily obtained. Further, examples of the non-aqueous solvent may include an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This makes it easy to improve the chemical stability of the electrolytic solution. The “unsaturated cyclic carbonate ester” described herein is a cyclic carbonate ester having one or two or more unsaturated bonds (carbon-carbon double bonds or carbon-carbon triple bonds). Examples of the unsaturated cyclic carbonate ester include vinylene carbonate, vinyl ethylene carbonate, and/or methylene ethylene carbonate. The “halogenated carbonate ester” is a cyclic or chain carbonate ester having one or two or more halogen elements as constituent elements. When the halogenated carbonate ester contains two or more halogens as a constituent element, the kind of the two or more halogens may be one kind or two or more kinds. Examples of the cyclic halogenated carbonate esters include 4-fluoro-1,3-dioxolan-2-one and/or 4,5-difluoro-1,3-dioxolan-2-one. Examples of the chain halogenated carbonate esters include fluoromethyl methyl carbonate, bis(fluoromethyl) carbonate, and/or difluoromethyl methyl carbonate. Examples of the sulfonate ester include a monosulfonate ester and/or a disulfonate ester. The monosulfonate ester may be a cyclic monosulfonate ester or a chain monosulfonate ester. Examples of the cyclic monosulfonate ester include sultones such as 1,3-propane sultone and/or 1,3-propene sultone. Examples of the chain monosulfonate ester include a compound in which a cyclic monosulfonate ester is cleaved in the middle. The disulfonate ester may be a cyclic disulfonate ester or a chain disulfonate ester. Examples of the acid anhydride include carboxylic anhydrides, disulfonic anhydrides, and/or carboxylic sulfonic anhydrides. Examples of the carboxylic anhydride include succinic anhydride, glutaric anhydride, and/or maleic anhydride. Examples of the disulfonic anhydride include ethanedisulfonic anhydride and/or propanedisulfonic anhydride. Examples of the carboxylic sulfonic anhydrides include anhydrous sulfobenzoic acid, anhydrous sulfopropionic acid, and/or anhydrous sulfobutyric acid. Examples of the dinitrile compound include a compound represented by NC—R1-CN (R1 is an alkylene group or an arylene group). Examples of the dinitrile compound include succinonitrile (NC—C₂H₄—CN), glutaronitrile (NC—C₃H₆—CN), adiponitrile (NC—C₄H₈—CN), and phthalonitrile (NC—C₆H₄—CN). Examples of the diisocyanate compound include a compound represented by OCN—R2-NCO (R2 is an alkylene group or an arylene group). Examples of the diisocyanate compound include hexamethylene diisocyanate (OCN—C₆H₁₂—NCO). Examples of the phosphate ester include trimethyl phosphate and triethyl phosphate. The chain compound having a carbon-carbon triple bond is a chain compound having one or two or more carbon-carbon triple bonds (—C≡C—). Examples of the chain compound having a carbon-carbon triple bond include propargyl methyl carbonate (CH≡C—CH₂—O—C(═O)—O—CH₃) and propargyl methyl sulfonate (CH≡C—CH₂—O—S(═O)₂—CH₃).

For example, the electrolyte salt included in the electrolytic solution may include any one or two or more of salts such as a lithium salt. The electrolyte salt may contain a salt other than a lithium salt, for example. The salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because more excellent battery capacity, cycle characteristics, and/or storage characteristics can be easily obtained. Among them, one or two or more of lithium hexafluorophosphate, lithium tetrafluoroborate, lithium perchlorate, and lithium hexafluoroarsenate may be used.

The exterior body 20 to be used for the secondary battery corresponds to a member that encloses a battery assembly formed by stacking electrode-constituting layers including a positive electrode, a negative electrode, and a separator as a battery exterior body. Such an exterior body 20 can also be referred to as, for example, a “battery can”. The exterior body 20 may have, for example, a hollow structure in which one end portion is closed and an opening is provided at the other end portion. The opening may be a through hole formed in one end portion of the exterior body. The structure of the exterior body including such an opening can also be understood as a structure including an open end portion whose one end is released. A safety valve may be provided in the opening of the exterior body. Although it is merely an example, a safety valve may be provided in the opening of the exterior body together with a battery lid, a thermosensitive resistive element, and the like.

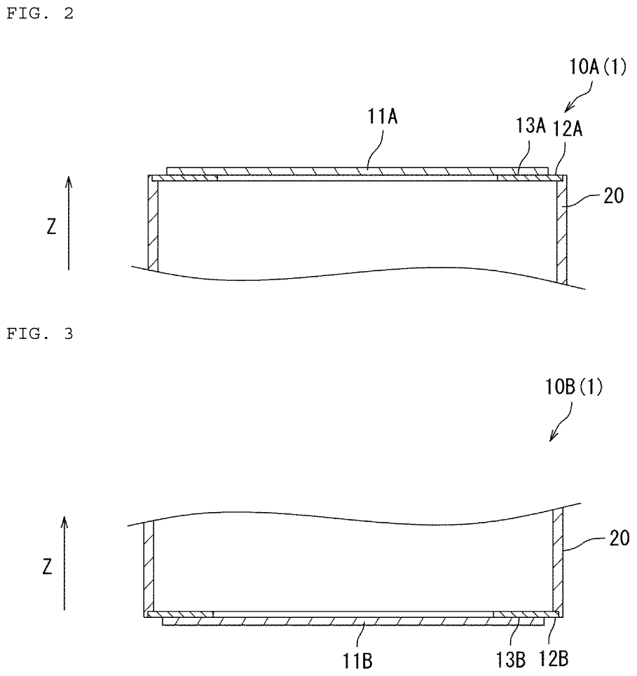

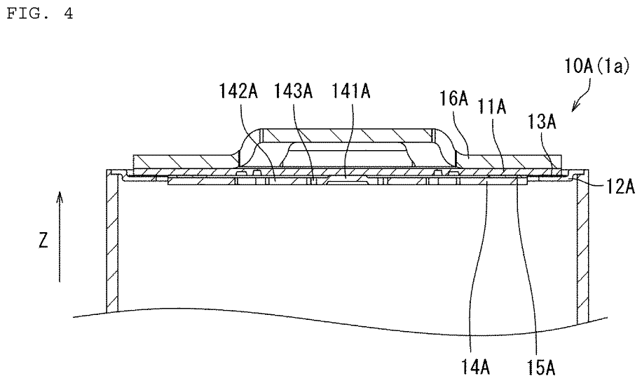

The first embodiment of the present disclosure relates to a battery (especially, cylindrical battery) 1. The battery 1 will be described with reference to FIGS. 1, 2 and 3. FIG. 2 is an enlarged sectional view of a part A in FIG. 1. FIG. 3 is an enlarged sectional view of a part B in FIG. 1. In FIGS. 1 to 3, the Z direction is parallel to the cylindrical axial direction of the battery (battery axis direction). The “cylindrical axial direction of the battery” referred to herein corresponds to the central axis of the cylindrical exterior body 20. The “battery axis” referred to herein corresponds to a rotation axis of a cylindrical battery. The radial direction refers to a direction perpendicular to the battery axis.

In the present specification, the term “cylinder” means that a cylindrical shape has a large ratio (aspect ratio) of the height to the equivalent circle diameter of the bottom surface (for example, an aspect ratio of 1 or more). Here, the equivalent circle diameter of a bottom surface refers to the diameter of a circle having an area equal to the area of the bottom surface.

As illustrated in FIGS. 1 to 3, the battery 1 according to the first embodiment includes a cylindrical exterior body 20 that houses a battery element, and safety valves 10A, 10B that are disposed at both end portions of the exterior body 20. The safety valves 10A, 10B include first metal members 11A, 11B, support portions 12A, 12B provided so as to support the first metal members 11A, 11B at the peripheral edges of the first metal members 11A, 11B and having openings, and first insulating members connecting the first metal members 11A, 11B to the support portions 12A, 12B and containing a thermoplastic resin.

In FIGS. 1 to 3, the sign of each member of the safety valve disposed on the upper side (forward Z direction side) contains “A”, and the sign of each member of the safety valve disposed on the lower side (reverse Z direction side) contains “B”.

The battery 1 according to the first embodiment can provide a battery further superior in safety. The reason is presumed as follows.

In the battery 1 according to the first embodiment, the safety valves 10A, 10B include the first insulating members 13A, 13B that connect the first metal members 11A, 11B to the support portions 12A, 12B and contain a thermoplastic resin. Therefore, the first insulating members 13A, 13B insulate the first metal members 11A, 11B from the support portions 12A, 12B during normal use (in a normal state), thereby preventing communication between the inside and the outside of the battery 1. On the other hand, when an abnormality occurs during use of the battery 1 (when the battery 1 is in an abnormally high temperature state), the thermoplastic resin contained in the first insulating members 13A, 13B is softened by heat, and a gas discharge path that makes the inside and the outside of the battery 1 communicate with each other is formed in the safety valves 10A, 10B. Therefore, it is possible to inhibit a rapid increase in the internal pressure of the battery 1 due to gas generation inside the battery 1 (hereinafter, a safety mechanism that operates in this manner is also referred to as “heat release mechanism”). As described above, the battery 1 according to the first embodiment is further superior in safety.

In the present specification, the term “normal state” indicates a state where the pressure of the inside of the battery 1 (the internal pressure of the battery 1), namely, the internal pressure of the exterior body 20 is within a normal range, wherein the safety mechanism (the heat release mechanism described above, and the first metal member cleavage mechanism (or “safety cover cleavage mechanism”) is not in operation.

In addition, the “abnormally high temperature state” means a state in which gas is abnormally generated inside the battery 1 because of an increase in the temperature inside the battery 1. For example, the “abnormally high temperature state” is a state in which the temperature of the battery 1 is 200° C. or higher.

The battery 1 includes safety valves 10A, 10B and an exterior body 20. Each member will be described below.

The safety valves 10A, 10B are disposed at both end portions of the cylindrical exterior body 20. The shapes of the safety valves 10A, 10B may be a circular shape, a polygonal shape, or other shapes in plan view (namely, when viewed in the Z direction). In the present specification, the “circular shape” is, for example, a perfect circle (true circle), an ellipse, a substantial circle, or the like. The substantial circle is, for example, a generic name of a partly or fully distorted shape of a perfect circle. The “polygonal shape” is, for example, a triangle, a quadrangle, a pentagon, a hexagon, or the like. The “other shapes” are, for example, shapes other than a circle whose outline is formed only by a curve, shapes in which two or more of polygonal shapes are combined, and shapes in which one or more of circles and one or more of polygonal shapes are combined. Such a definition is the same hereinafter. In the illustrated exemplary aspect, the outer contour shape in plan view of each of the safety valves 10A, 10B is a circular shape.

The safety valves 10A, 10B include first metal members 11A, 11B, support portions 12A, 12B, and first insulating members 13A, 13B. These members and portions will be described in detail below.

The first metal members 11A, 11B are supported at the peripheral edges thereof by the support portions 12A, 12B. The first metal members 11A, 11B are connected to the support portions 12A, 12B with the first insulating members 13A, 13B interposed therebetween.

The first metal members (also referred to as “safety covers”) 11A, 11B mainly close both opening ends of the exterior body 20.

The first metal members 11A, 11B are electrically connected to the battery element housed in the exterior body 20, and can serve as external terminals.

The first metal members 11A, 11B are each made of a metal member and have conductivity. For example, the first metal members 11A, 11B may include at least one metal among metal materials such as aluminum (aluminum alloys such as A1050, A3203, and A5052), titanium, platinum, and gold.

The planar shape of the first metal members 11A, 11B, that is, the outer contour shape in plan view (also referred to as “outer contour shape in plan view”) viewed along the battery axis direction is not particularly limited, and it may be, for example, a circular shape, a polygonal shape, and other shapes. In the illustrated exemplary aspect, the outer contour shape in plan view of each of the first metal members 11A, 11B is a circular shape.

The first metal members 11A, 11B may have, for example, a flat plate shape as a whole. That is, the first metal members 11A, 11B may have a form extending on the same plane.

To each of the first metal members 11A, 11B is electrically connected a conductive member extending from the battery assembly. The conductive member may be a conductive member containing metal, and preferably may be a metal member having an elongated shape. For example, the conductive member may include an electrode current collector of the battery assembly, or may be a current collecting lead provided in the battery assembly (in particular, in its electrode). When the conductive member includes an electrode current collector, the conductive member may include a portion of the electrode current collector where the electrode material is not provided. When the conductive member 15 is a current collecting lead, the conductive member may include a metal member having a thin form and/or a long form, and may be connected to an electrode. In the present disclosure, the conductive member that electrically connects the battery assembly and the electrode terminal to each other can also be referred to as “tab”. The conductive member used for the secondary battery preferably has flexibility, and it may be provided in a warped form and/or a bent form.

The support portions 12A, 12B are provided so as to support the first metal members 11A, 11B at the peripheral edges of the first metal members 11A, 11B, and have openings.

The support portions 12A, 12B are provided at both opening ends of the exterior body 20 so as to protrude from the exterior body 20 toward the battery axis. The support portions 12A, 12B have openings. The support portions 12A, 12B support the first metal members 11A, 11B disposed so as to close the openings.

The support portions 12A, 12B are connected to the cylindrical exterior body 20 at both opening ends of the exterior body 20. The support portions 12A, 12B may be portions continuous from the exterior body 20. That is, the support portions 12A, 12B each may be integrated with the exterior body 20. More specifically, the members forming the support portions 12A, 12B may be bent toward the battery axis at the edges (both opening ends) of the exterior body 20 and correspond to portions of the exterior body 20 protruding toward the inner peripheral side thereof. In one embodiment, the support portions 12A, 12B each may correspond to an overhanging surface formed on an edge of the exterior body 20 by crimping one open end of the exterior body 20.

Alternatively, the support portions 12A, 12B may be separate members from the exterior body 20 (see FIGS. 1 to 3). That is, the support portions 12A, 12B each may have an outer contour shape in plan view corresponding to the plan view shape of an edge of the exterior body 20, and may be combined with the edge of the exterior body 20 using a welding method or the like. A through hole is formed in each of the regions surrounded by the support portions 12A, 12B, and the through holes correspond to the opening ends of the exterior body 20. The battery 1 including the exterior body 20 having such a structure can have, for example, a structure without a beading part. In other words, this structure is a structure in which the outer surface of the exterior body 20 is parallel to the battery axis direction.

The “beading part” refers to a part constricted toward the battery axis side in the exterior body. In other words, the “beading part” is a part that is constricted to protrude toward the inside of the exterior body, and can also be referred to as “constricted part” or a “narrowed portion”. Conventionally, in a battery including an exterior body having the beading part, a support member such as a gasket is disposed in the beading part, and safety valves 10A, 10B are held inside the exterior body with the gasket portion interposed therebetween. That is, the conventional safety valves 10A, 10B (namely, the heat release mechanism) are disposed inside the exterior body provided with the beading part.

On the other hand, according to the present disclosure, since the safety valves 10A, 10B can be disposed at both end portions of the exterior body 20, the safety valves 10A, 10B can be disposed without depending on the beading part. Thus, the safety valves 10A, 10B can be disposed not only on the exterior body including the beading part but also on the exterior body not including the beading part. By disposing the safety valves 10A, 10B on the further outer side of the battery 1, it is possible to secure a wider internal space of the exterior body 20 where the battery assembly can be disposed as compared with the battery including the beading part. That is, according to the present disclosure, since the safety valves 10A, 10B can be disposed also on an exterior body 20 which enables high energy density, a battery 1 having high energy density and being superior in safety can be obtained.

The support portions 12A, 12B may be conductive members. For example, the support portions 12A, 12B each may include one of, or two or more of metal materials such as iron, aluminum, stainless steel, and alloys thereof. The support portions 12A, 12B may be made of the same material or different materials. For example, any one of, or two or more of metal materials such as nickel may be plated on the surfaces of the support portions 12A, 12B. When the support portions 12A, 12B and the exterior body 20 to be described later are all conductive members, the support portions 12A, 12B and the exterior body 20 can be electrically connected to each other.

The first insulating members 13A, 13B insulate the first metal members 11A, 11B from the support portions 12A, 12B, and contain a thermoplastic resin. The first insulating members 13A, 13B may be made of a thermoplastic resin.

The first insulating members 13A, 13B are disposed at circumferential portions where the first metal members 11A, 11B and the support portions 12A, 12B overlap in the battery axis direction.

The first insulating members 13A, 13B are interposed between the first metal members 11A, 11B and the support portions 12A, 12B. The first insulating members 13A, 13B electrically insulate the first metal members 11A, 11B from the support portions 12A, 12B.

In addition, the first insulating members 13A, 13B can seal between the first metal members 11A, 11B and the support portions 12A, 12B in a normal state. Therefore, the first insulating members 13A, 13B isolate the inside and the outside of the battery 1 from each other.

On the other hand, in an abnormally high temperature state, the thermoplastic resin contained in the first insulating members 13A, 13B is softened (and the adhesive force between the first metal members 11A, 11B and the support portions 12A, 12B decreases), a gas discharge path that makes the inside and the outside of the battery 1 communicate with each other can be formed. Therefore, in the abnormally high temperature state, the gas generated inside the battery 1 is discharged to the outside of the battery 1 through the gas discharge path formed by the safety valves 10A, 10B. As a result, a rapid increase in the internal pressure of the battery 1 is inhibited, and the battery 1 is further superior in safety.

From the viewpoint of further preventing volatilization of the electrolytic solution from the inside of the battery 1 and from the viewpoint of further preventing entry of moisture from the outside of the battery 1, the thermoplastic resin may include at least one resin selected from the group consisting of a super engineering plastic-based resin and a polyolefin-based resin in a preferred embodiment. Examples of the super engineering plastic-based resin include polyetheretherketone (PEEK), polyamideimide (PAI), polyphenylene sulfide (PPS), polyetherimide (PEI), polyetherketoneketone (PEKK), polyethylene naphthalate (PEN), super engineering plastic polysulfone (PSU), polyethersulfone (PES), polyarylate (PAR), polyamideimide (PAI), polyimide (PI), polybenzimidazole (PBI), polytetrafluoroethylene (PTFE), polychlorotrifluoroethylene (PCTFE), Neoflon (PFA), Fluon, Neoflon (ETFE), and polyvinylidene fluoride (PVDF). Examples of the polyolefin-based resin include polyolefin resins such as polyethylene, polypropylene, polymethylpentene, polybutene, ethylene-propylene copolymer, ethylene-α-olefin copolymer, and propylene-α-olefin copolymer, and polyolefin-based resins such as olefin-based copolymer resins, for example, ethylene-vinyl acetate copolymer, ethylene-vinyl alcohol copolymer, ethylene-(meth)acrylic acid (ester) copolymer, and ethylene-unsaturated carboxylic acid copolymer metal neutralized product (ionomer). Since the thermoplastic resin layer 140 contains the thermoplastic resin as described above, the thermoplastic resin layer is suitably softened when the battery is in an abnormally high temperature state, and it may be possible to thermally cleave between the support portions 12A, 12B and the safety valves 10A, 10B.

The melting point of the thermoplastic resin may be 320° C. or higher, 340° C. or higher, 350° C. or higher, or 360° C. or higher. When the melting point is in the above-described range, a battery 1 in which the thermal cleavage more suitably occurs in an abnormally high temperature state and which is further superior in safety can be obtained. When it is emphasized that the thermoplastic resin layer 140 appropriately adheres and seals spaces between the safety valves 10A, 10B and the exterior body 20 in a non-abnormally high temperature state, the melting point of the thermoplastic resin layer 140 may be, for example, 80° C. or higher.

The thermoplastic resin preferably includes a crystalline thermoplastic resin from the viewpoint of improving the resistance of the first insulating members 13A, 13B to the electrolytic solution.

The exterior body 20 has a cylindrical shape and houses a battery element. The exterior body 20 is connected to the safety valves 10A, 10B at both opening ends. The shape of the exterior body 20 is, for example, a cylinder or a polygonal prism. The “cylinder” is a cylinder whose bottom surface is, for example, a perfect circle (true circle), an ellipse, or a substantial circle. A “polygonal prism” is a polygonal prism whose bottom surface is, for example, a triangle, a quadrangle, a pentagon, or a hexagon. In the illustrated exemplary embodiment, the exterior body 20 has a cylindrical shape.

The exterior body 20 may be a conductive member. For example, the exterior body 20 may include one of, or two or more of metal materials such as iron, aluminum, stainless steel, and alloys thereof. The exterior body 20 may be made of the same material or different materials. The surface of the exterior body 20 may be plated, for example, with any one or two or more of metal materials such as nickel.

The method for producing the battery 1 according to the present disclosure will be exemplarily described with reference to the method for producing a secondary battery as an example. The secondary battery according to the present disclosure can be produced by the following procedure, for example.

In the production of a positive electrode, a positive electrode active material is, as necessary, mixed with a positive electrode binder, a positive electrode conductive agent, and the like to obtain a positive electrode mixture. Subsequently, the positive electrode mixture is dispersed in, for example, an organic solvent to obtain a positive electrode mixture slurry in a paste form. Then, the positive electrode mixture slurry is applied to one side or both sides of the positive electrode current collector, and the positive electrode mixture slurry is dried to form a positive electrode active material layer. Thereafter, if necessary, the positive electrode active material layer may be compression-molded using a roll press machine or the like. In such a case, the positive electrode active material layer may be heated, or compression molding may be repeated multiple times. In the same manner, a negative electrode can be produced. Specifically, the negative electrode active material, the negative and positive electrode binder, the negative electrode conductive agent, and the like are mixed to obtain a negative electrode mixture. Subsequently, the negative electrode mixture is dispersed in an organic solvent or the like to obtain a paste-like negative electrode mixture slurry. Next, the negative electrode mixture slurry is applied to one side or both sides of the negative electrode current collector, and then the negative electrode mixture slurry is dried to form a negative electrode active material layer. Thereafter, if necessary, the negative electrode active material layer is compression-molded using a roll press machine or the like.

When the secondary battery is assembled, a positive electrode lead is connected to the positive electrode current collector by a welding method and the like and the negative electrode lead is also connected to the negative electrode current collector by a welding method and the like. Next, the positive electrode and the negative electrode are stacked with the separator interposed therebetween, and then, the positive electrode, the negative electrode, and the separator are wound to form a wound electrode body. Next, a center pin is inserted in a winding space of the wound electrode body. Then, while the wound electrode body is sandwiched between a pair of insulating plates, the wound electrode body is housed inside the exterior body together with the pair of insulating plates. In this case, one end portion of the positive electrode lead is connected to the first metal members 11A, 11B by a welding method or the like, and one end portion of the negative electrode lead is similarly connected to the exterior body 20 by a welding method or the like. Next, the electrolytic solution is injected into the exterior body 20, and the wound electrode body is impregnated with the electrolytic solution. Finally, the support portions 12A, 12B are provided on the exterior body 20, and the first metal members 11A, 11B are fixed on the support portions 12A, 12B with the first insulating members 13A, 13B interposed therebetween. Thereby, a secondary battery provided with a heat release mechanism is completed.

The second embodiment relates to a cylindrical battery. The cylindrical battery according to the second embodiment is different from the cylindrical battery 1 according to the first embodiment in further including a first metal member cleavage mechanism in addition to the heat release mechanism. In other words, the cylindrical battery according to the second embodiment mainly further includes a second metal member and a second insulating member. Hereinafter, this different configuration will be mainly described. In the second embodiment, the same reference numerals as those of the first embodiment denote the same configurations as those of the first embodiment, and thus the description thereof will be generally omitted.

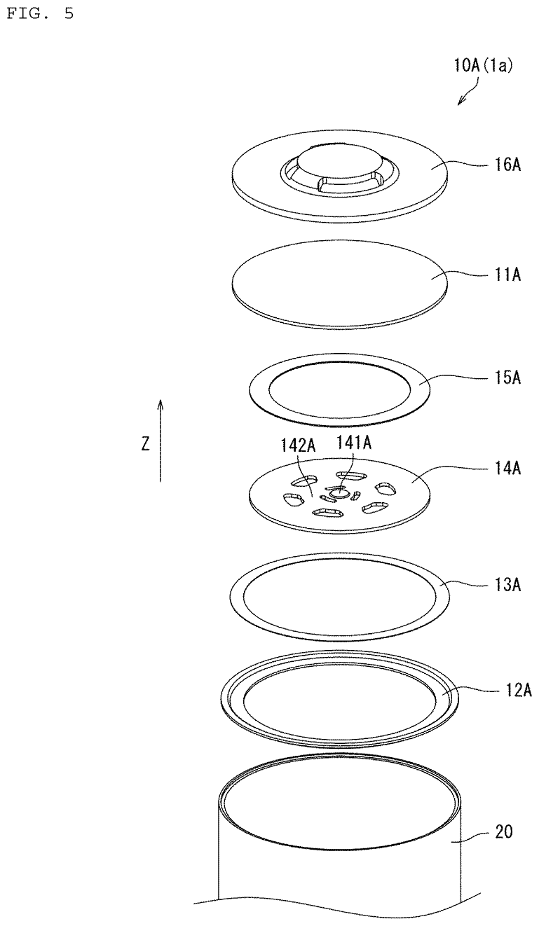

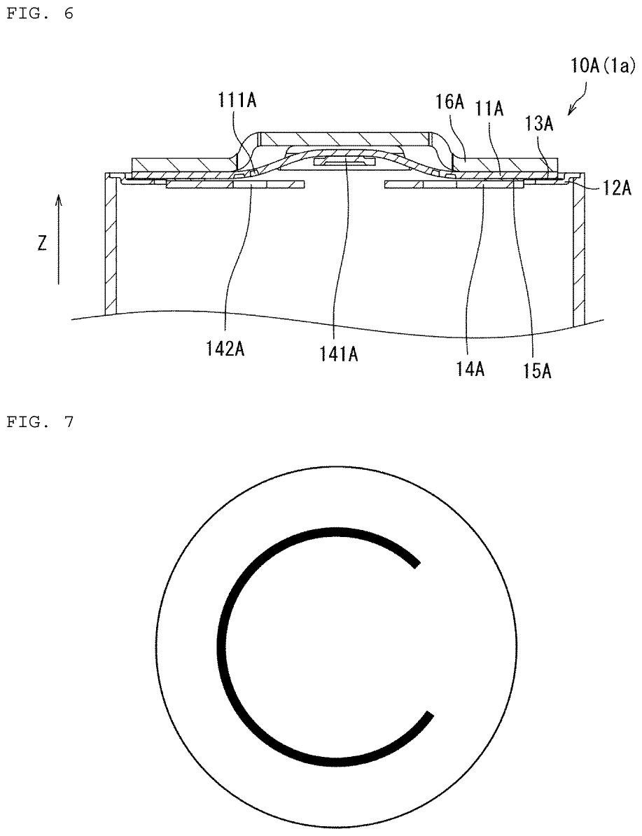

Hereinafter, the cylindrical battery according to the second embodiment will be described with reference to FIGS. 4, 5 and 6. FIG. 4 is a sectional view (in a normal state) schematically illustrating an end portion of a battery according to the second embodiment of the present disclosure. FIG. 5 is an exploded perspective view schematically illustrating an end portion of a battery according to the second embodiment of the present disclosure. FIG. 6 is a sectional view (in an abnormally high temperature state) schematically illustrating an end portion of a battery according to the second embodiment of the present disclosure.

The battery 1a according to the second embodiment further includes: in the safety valve 10A that is at least one of the two safety valves 10A, 10B disposed at both end portions of the cylindrical exterior body 20, the safety valve, a second metal member 14A provided on the inner surface side of the first metal members 11A, 11B and electrically connected to the first metal members 11A, 11B; a second insulating member 15A that connects the first metal members 11A, 11B and the peripheral edges of the second metal member 14A, and contains a thermosetting resin, in which the first metal members 11A, 11B each have a first groove portion on an inner side in a radial direction perpendicular to the battery axis corresponding to a rotation axis of the cylindrical battery with respect to a connection portion between the first metal members 11A, 11B and the peripheral edge of the second metal member 14A, and the second metal member 14A has a central portion electrically connected to the first metal members 11A, 11B, a second groove portion, and an outer peripheral portion surrounding the central portion with the second groove portion interposed.

The cylindrical battery 1a according to the second embodiment is further superior in safety. The reason is presumed as follows. The cylindrical battery 1a further includes a second metal member 14A and a second insulating member 15A. The first metal members 11A, 11B have first groove portions on the inner side in the radial direction perpendicular to the battery axis corresponding to the rotation axis of the cylindrical battery with respect to the connection portion between the first metal members 11A, 11B and the peripheral edge of the second metal member 14A. The second metal member 14A has a central portion electrically connected to the first metal members 11A, 11B, a second groove portion, and an outer peripheral portion surrounding the central portion with the second groove portion interposed. When an abnormality occurs during use of the battery 1 (in an abnormally high temperature state), gas is generated inside the battery 1a, and the internal pressure increases. As the internal pressure increases, stress is applied to the second metal member 14A, the second metal member 14A is cut at the second groove portion, and the central portion is separated from the outer peripheral portion. As a result, the electrical connection between (the outer peripheral portion of) the second metal member 14A and the first metal member 11A is interrupted (the safety mechanism operating in this manner is also referred to as “first metal member cleavage mechanism”). Therefore, since such a first metal member cleavage mechanism operates in addition to the heat release mechanism, the cylindrical battery 1a according to the second embodiment is further superior in safety.

In the present embodiment, the central portion of the second metal member 14A is separated from the outer peripheral portion (peripheral edge portion) 142A, so that an opening is formed. Therefore, the formed opening can be a path through which the gas generated inside the battery 1a is discharged to the outside of the battery 1a, so that the heat release mechanism operates more effectively. Here, the central portion includes the protruding portion 141A in the second metal member 14A of FIGS. 4 and 5, and is connected to the inner edge of the outer peripheral portion 142A with the second groove portion 143A interposed therebetween.

The safety valve 10A includes, as a safety mechanism, a mechanism (first metal member cleavage mechanism) that contributes to a battery terminal (that is, an external terminal of the positive electrode or the negative electrode) and can be varied according to an excessive internal pressure of the battery 1a. More specifically, the safety valve 10A includes, as constituent elements, at least a first metal member 11A and a second metal member 14A that are displaceable in response to excessive internal pressure of the battery, a second insulating member 15A disposed therebetween, a support portion 12A that supports the first metal member 11A, and a first insulating member 13A that connects the first metal member 11A and the support portion 12A. One exemplary embodiment will be described below by taking an embodiment in which the first metal member 11A can correspond to a safety cover and the second metal member 14A can correspond to a stripper disk as an example.

As illustrated in FIGS. 4 and 5, the safety valve 10A has a configuration in which a first metal member 11A, a second insulating member 15A, a second metal member 14A, a first insulating member 13A, and a support portion 12A are combined with each other in this order. When viewed along an axial direction of the cylindrical shape of the battery 1a, the first metal member 11A is relatively positioned on the outer side of the battery (that is, for example, the side farther from the battery assembly such as the wound structure body), and the second metal member 14A is relatively positioned on the inner side of the battery 1a (that is, for example, the side closer to the battery assembly such as the wound structure body). The second insulating member 15A is interposed between the first metal member 11A and the second metal member 14A.

The safety valve 10A includes a first metal member 11A, a support portion 12A provided so as to support the first metal member 11A at the peripheral edge of the first metal member 11A and having an opening, and a first insulating member 13A connecting the first metal member 11A and the support portion 12A and containing a thermoplastic resin, and further includes a second metal member 14A provided on the inner surface side of the first metal member 11A and electrically connected to the first metal member 11A, and a second insulating member 15A connecting the first metal member 11A and the peripheral edges of the second metal member 14A and containing a thermosetting resin. The second metal member 14A is disposed in the opening of the support portion 12A. The second metal member 14A includes a protruding portion disposed at the center and protruding relatively outward with respect to the battery axis and electrically connected to the first metal member 11A, and a peripheral edge portion disposed at the peripheral edge of the protruding portion and connected to the first metal member 11A with the second insulating member 15A interposed therebetween.

Such a safety valve 10A is provided at at least one opening end of the exterior body 20. The safety valve 10A may further include a top cover 16A. The top cover 16A may be provided outside in the battery axis direction with respect to the first metal member 11A. Hereinafter, each member constituting the safety valve 10A will be described in more detail.

The first metal member 11A corresponds to a displaceable member that is deformable and/or cleavable according to the internal pressure of the exterior body 20. As described above, the internal pressure of the exterior body 20 may be undesirably increased by the gas such as carbon dioxide generated when the battery 1a falls in an abnormally high temperature state. The first metal member 11A may be deformable and/or cleavable in accordance with such an increase in internal pressure. The first metal member 11A can be deformed toward the outside of the battery axis by the gas generated in an abnormally high temperature state.

The first metal member 11A may have a substantially constant thickness except for the first groove portion 111A and the like provided in the first metal member 11A. The first metal member 11A has a substantially circular shape in plan view.

The second metal member 14A is disposed inside the battery 1a with respect to the first metal member 11A with the second insulating member 15A interposed therebetween. The second metal member 14A corresponds to a member that contributes to the interrupt of the electrical connection between the battery assembly disposed inside the exterior body 20 and the first metal member 11A and/or the top cover 16A.

The second metal member 14A is disposed in the opening of the support portion 12A. The second metal member 14A includes a protruding portion 141A disposed at the center and protruding relatively outward with respect to the battery axis and electrically connected to the first metal member 11A, and an outer peripheral portion 142A disposed at the peripheral edge of the protruding portion 141A and connected to the first metal member 11A with the second insulating member 15A interposed therebetween.

The second metal member 14A is provided with a second groove portion 143A for interrupting a current path when the battery 1a is in an abnormal state. The second groove portion 143A may be provided, for example, concentrically from the center in such a manner as to surround the battery axis. The second groove portion 143A may have a continuous annular shape surrounding the battery axis, or may have an intermittent annular shape. Alternatively, instead of the second groove portion 143A, (or together with the second groove portion 143A,) linear through holes may be intermittently provided around the battery axis. The second groove portion 143A may be a groove having an opening toward the outside of the battery axis. That is, the second groove portion 143A may have a groove opening on the surface facing the outside of the battery 1a relatively in the battery axis direction among the surfaces of the second metal member 14A. Since the protruding portion 141A is connected to the first metal member 11A, the second metal member 14A is also deformed following the deformation of the first metal member 11A toward the outside of the battery axis at an abnormally high temperature, and the second metal member 14A is cleaved at the second groove portion 143A, and can be separated into the protruding portion 141A and the other portion. Since the second metal member 14A is separated in this way, the current is interrupted.

The second metal member 14A may be a conductive member. For example, the second metal member 14A may include any one of, or two or more of metal materials such as aluminum (aluminum alloys such as A1050, A3203, and A5052), titanium, platinum, and gold. The material of the second metal member 14A may be the same as the material of the first metal member 11A, or may be a material different from the material of the first metal member 11A.

The outer contour shape in plan view of the second metal member 14A is not particularly limited, and may be, for example, a circular shape, a polygonal shape, or another shape. The contour shape in plan view of the second metal member 14A may be the same as the contour shape in plan view of the first metal member 11A. In the illustrated exemplary aspect, the outer contour shape in plan view of the first metal member 11A is a circular shape.

The second metal member 14A may have, for example, a flat plate shape as a whole. That is, the second metal member 14A may have a form extending on the same plane. For example, the second metal member 14A may have a substantially constant thickness except for the second groove portion 143A and the like provided in the second metal member 14A. In addition, the central region of the second metal member 14A may be relatively thick as compared with other regions in order to contribute to connection to the first metal member 11A. In other words, although the second metal member 14A has a plate shape as a whole, the thickness of the central portion of the region including the battery axis may be relatively large as compared with the outer peripheral portion 142A.

In the safety valve 10A, while the first metal member 11A and the second metal member 14A are integrated by the second insulating member 15A interposed therebetween, they may be electrically connected to each other in a central region thereof. For example, the first metal member 11A may be directly connected to the central region of the second metal member 14A so as to straddle the second insulating member 15A. More specifically, as illustrated in FIG. 4, the central region of the first metal member 11A and the central region of the second metal member 14A may be directly connected to each other through the opening region of the second insulating member 15A. In such a case, the central region of the first metal member 11A and the central region of the second metal member 14A may, in addition, be electrically connected.

The second metal member 14A may have a plurality of openings arranged concentrically with respect to the center (battery axis) in plan view. The openings can serve as passage ports for a gas generated at an abnormally high temperature.

The second insulating member 15A is interposed between the first metal member 11A and the second metal member 14A, and corresponds to a member that enables at least the first metal member 11A and the second metal member 14A to be connected to each other. The second insulating member 15A insulates the electrical connection between the first metal member 11A and the second metal member 14A at their peripheral edge portions. As a result, the first metal member 11A is electrically connected only to the protruding portion 141A of the second metal member 14A. Therefore, the current can be interrupted through the cleavage of the second metal member 14A by the gas generated at an abnormally high temperature.

The second insulating member 15A may have an annular shape as a whole. That is, the plan view shape of the second insulating member 15A may be a loop shape, a ring shape, or the like. Because of such an annular shape, a loop shape, or a ring shape, the second insulating member 15A may form a hollow portion or an opening region in its central region. The outer contour shape in plan view of the second insulating member 15A is not particularly limited, but may be the same as the outer contour shape in plan view of the first metal member 11A, or may be the same as the outer contour shape in plan view of the second metal member 14A. For example, the contour shape in plan view can be a circular shape. The annular shape, the loop shape, or the ring shape of the second insulating member 15A may be a continuous form as a whole of the member, or may be a form in which the insulating member is locally divided and/or cut away.

The second insulating member 15A may have, for example, a flat plate shape as a whole. That is, the second insulating member 15A may have a form extending on the same plane. Although merely in an example, the thickness of the second insulating member 15A may be substantially constant between the first metal member 11A and the second metal member 14A.

The second insulating member 15A is a member having an insulation property. Thus, electrical conduction via the second insulating member 15A is preferably prevented. The “Insulation” referred to herein may have the insulation property of common insulators, and thus have the electrical resistivity of the common insulators. The second insulating member 15A may have a resistivity of at least 1.0×10⁵Ω·m or more, preferably 1.0×10⁶Ω·m or more, and more preferably 1.0×10⁷Ω·m or more (room temperature: 20° C.) although it is merely an example. The first insulating members 13A, 13B can also have a resistivity equivalent to that of the second insulating member 15A.

In a preferred embodiment, the second insulating member 15A interposed between the first metal member 11A and the second metal member 14A is in adhesion to these members. In other words, the second insulating member 15A may be interposed between the first metal member 11A and the second metal member 14A as an adhesive layer. Preferably, the second insulating member 15A may be interposed between the first metal member 11A and the second metal member 14A such that the opening region of the insulating member is positioned in the region including the battery axis. The opening region is positioned at a position corresponding to the central region of the first metal member 11A. The plan view shape of the opening region is not particularly limited, and the shape may be, for example, the same as the outer contour shape in plan view of the first metal member 11A. In the illustrated exemplary aspect, the plan view shape of the opening region is a circular shape.

The second insulating member 15A preferably includes an insulating resin material. This is because the resin material can suitably contribute to the close contact between the first metal member 11A and the second metal member 14A while ensuring the insulation property, and thus contributes to the realization of a thinner safety valve 10A. When the second insulating member 15A includes a resin material, for example, the second insulating member 15A may include a thermosetting resin, a thermoplastic resin, and/or a UV curable resin. When the viewpoint of adhesiveness is particularly emphasized, the second insulating member 15A may be a member containing a resin adhesive having an insulation property. Examples of such a resin adhesive include an acrylic resin adhesive material such as an acrylic acid ester copolymer, a silicone-based resin adhesive material such as silicone rubber, a urethane-based resin adhesive material such as a urethane resin, an α-olefin-based resin adhesive, an ether-based resin adhesive, an ethylene-vinyl acetate resin-based resin adhesive material, an epoxy resin-based resin adhesive material, a vinyl chloride resin-based resin adhesive material, a chloroprene rubber-based resin adhesive material, a cyanoacrylate-based resin adhesive material, an aqueous polymer-isocyanate-based resin adhesive material, a styrene-butadiene rubber-based resin adhesive material, a nitrile rubber-based resin adhesive material, a nitrocellulose-based resin adhesive material, a reactive hot-melt-based resin adhesive material, a phenol resin-based resin adhesive material, a silicone-based resin adhesive material, a polyamide resin-based resin adhesive material, a polyimide-based resin adhesive material, a polyurethane resin-based resin adhesive material, a polyolefin resin-based resin adhesive material, a polyvinyl acetate resin-based resin adhesive material, a polystyrene resin solvent resin adhesive material, a polyvinyl alcohol-based resin adhesive material, a polyvinyl pyrrolidone resin-based resin adhesive material, a polyvinyl butyral resin-based resin adhesive material, a polybenzimidazole-based resin adhesive material, a polymethacrylate resin-based resin adhesive material, a melamine resin-based resin adhesive material, an urea resin-based resin adhesive material, and/or a resorcinol-based resin adhesive material.

As described above, the safety valve 10A may further include the top cover 16A. That is, the top cover 16A may be further provided relatively outside the first metal member 11A in the battery axis direction. The top cover 16A may be provided with a plurality of openings. When the gas staying inside the exterior body 20 has been leaked through the cleaved portion of the first metal member 11A, the plurality of openings mainly correspond to discharge ports that contribute to passage or release of the leaked gas to the outside of the exterior body 20.

The top cover 16A is a conductive member, and may be, for example, a metal member. For example, the top cover 16A may include any one of, or two or more of metal materials such as aluminum (aluminum alloys such as A1050, A3203, and A5052), titanium, platinum, iron, and gold. Further, the metal member may be formed by plating these metals with another metal and, for example, the metal member may be one formed by plating iron with nickel.

The top cover 16A is preferably electrically connected to the first metal member 11A. In such a case, the top cover 16A can function as an external terminal of the battery 1a. For example, the top cover 16A may function as a positive electrode terminal of the battery, and the exterior body 20 may function as a negative electrode terminal. Thus, the top cover 16A and the exterior body 20 may be insulated from each other.

A conductive member extending from the battery assembly is connected to the safety valve 10A. More specifically, the conductive member is connected to the second metal member 14A of the safety valve 10A. In particular, the conductive member 15 may be connected to a non-central region, which is a region on the outer peripheral side of the second metal member 14A with respect to the second groove portion 143A. The “non-central region” is a region other than the central region on the inner peripheral side with respect to the second groove portion 143A, and can also be referred to as an “outer peripheral region”. The conductive member 15 is electrically connected to the battery assembly (in particular, any one of the positive electrode and the negative electrode), and contributes to electrical connection between the battery assembly and the safety valve 10A (in particular, the second metal member 14A). In the safety valve 10A, the second metal member 14A is electrically connected to the first metal member 11A with a central region of the second metal member 14A interposed therebetween. The first metal member 11A is electrically connected to the top cover 16A forming an external terminal of the battery. Thus, the battery assembly such as a wound structure body is electrically connected to the external terminal of the battery 1a with the conductive member 15 interposed therebetween.

The operation of the safety mechanism (first metal member cleavage mechanism) according to the battery 1a will be described with reference to FIGS. 4 and 6.

For example, when gas is generated inside the exterior body 20 because of a side reaction such as a decomposition reaction of an electrolytic solution accompanying overcharge, the gas is accumulated inside the exterior body 20, and the internal pressure of the exterior body 20 increases. When the internal pressure of the exterior body 20 continues to increase, the second metal member 14A and the first metal member 11A are affected by the increase in the internal pressure. When the internal pressure of the exterior body 20 exceeds a predetermined pressure, the central region of the first metal member 11A is pushed up and displaced toward the outside of the battery along the battery axis P direction as illustrated in FIG. 6. With such displacement, the central region of the second metal member 14A is also pushed up in the displacement direction, and is broken starting from the second groove portion 143A provided in the second metal member 14A. In the present specification, “breaking” means that the connection is fully cut off. This causes the second metal member 14A to be divided into the central region on the inner peripheral side with respect to the second groove portion 143A and the non-central region on the outer peripheral side with respect to the second groove portion 143A. More specifically, the second metal member 14A is divided into a central region connected to the first metal member 11A and a non-central region connected to the conductive member. As can be seen from the form illustrated in FIG. 6, such division physically separates the first metal member 11A and the non-central region of the second metal member 14A from each other. Thus, the electrical connection between the top cover 16A and the battery assembly is interrupted, and the current path flowing between the top cover 16A and the battery assembly is cut off. In this manner, it is possible to interrupt the current of the battery 1a when the internal pressure has abnormally increased.

When the first metal member cleavage mechanism described above operates and then the displacement of the first metal member 11A due to the internal pressure further proceeds, the first metal member 11A can be cleaved or broken starting from the first groove portion 111A provided in the first metal member 11A (see FIG. 6). Here, the first metal member 11A is displaced such that this does not to come into contact with the top cover 16A. The term “cleavage” in the present specification includes a form in which at least a part is divided while a part is continuous. That is, in the first metal member 11A, the central region on the inner peripheral side of the first groove portion 111A and the non-central region on the outer peripheral side of the first groove portion 111A do not have to be fully separated, or they may be fully separated. When the first metal member 11A is cleaved, the inside and the outside of the battery 1a communicate with each other. As a result, the gas inside the exterior body 20 is released to the outside from the cleaved portion, and the internal pressure decreases. In such a case, the gas discharge path through the plurality of openings formed in the top cover 16A is released, and the gas can be released to the outside of the battery through the openings. In one embodiment, the second metal member 14A may also have an opening, and the gas contained inside the exterior body 20 may be released to the outside through the second metal member 14A.

The battery 1a includes the heat release mechanism and the first metal member cleavage mechanism. These mechanisms operate when the internal pressure reaches a certain threshold. The first insulating member release pressure P₁ of the heat release mechanism is lower than the safety valve cleavage pressure P₂ of the first metal member cleavage mechanism. Therefore, in the abnormally high temperature state, when the internal pressure of the battery 1a increases, the heat release mechanism acts first, and then the first metal member cleavage mechanism operates.

Although embodiments of the present disclosure have been described above, the above-described embodiments are merely typical examples. The present disclosure is not limited to the above-described embodiments, and can be modified in design without departing from the gist of the present disclosure. In addition, the configurations in the first and second embodiments may be variously combined.

In the second embodiment, the battery 1a has the first metal member cleavage mechanism in only one safety valve 10A, but the present invention is not limited to this configuration. For example, the battery may have a current cleaving mechanism in both the safety valves 10A, 10B disposed at both end portions. This embodiment is further superior in safety than the battery 1a according to the second embodiment.

The embodiments of the battery of the present disclosure are as follows according to an embodiment.

<1>

A battery that is a cylindrical battery including:
a cylindrical exterior body that houses a battery element; and
safety valves disposed at both end portions of the exterior body, in which each of the safety valves includes:
   a first metal member;
   a support portion that is provided to support the first metal member at a peripheral edge portion of the first metal member and has an opening; and
   a first insulating member that connects the first metal member and the support portion and contains a thermoplastic resin.
      <2>

The battery according to <1>, in which the thermoplastic resin includes at least one resin selected from the group consisting of a super engineering plastic-based resin and a polyolefin-based resin.

<3>

The battery according to <1> or <2>, in which in a normal state, the first insulating member seals between the metal member and the support portion.

<4>

The battery according to any one of <1> to <3>, in which in an abnormally high temperature state, the thermoplastic resin is softened to form a gas discharge path that makes an inside of the battery and an outside of the battery communicate with each other.

<5>

The battery according to any one of <1> to <4>, in which an outer surface of the exterior body has a structure not including a beading part.

<6>

The battery according to any one of <1> to <5>, in which
at least one of the safety valves disposed at both the end portions further includes:
   a second metal member that is provided on an inner surface side of the first metal member and electrically connected to the first metal member; and
   a second insulating member that connects the first metal member and a peripheral edge of the second metal member and contains a thermosetting resin,
the first metal member has a first groove portion on an inner side in a radial direction perpendicular to a battery axis corresponding to a rotation axis of the cylindrical battery, with respect to a connection portion between the first metal member and the peripheral edge of the second metal member, and
the second metal member has a central portion electrically connected to the first metal member, a second groove portion, and an outer peripheral portion surrounding the central portion with the second groove portion interposed between the outer peripheral portion and the central portion.
   <7>

The battery according to <6>, in which
the second metal member is disposed in the opening of the support portion, and
the second metal member includes:
   a protruding portion that is disposed at a center, protrudes relatively outward with respect to a battery axis, and is electrically connected to the first metal member; and
   a peripheral edge portion that is disposed on a peripheral edge of the protruding portion and is connected to the first metal member with the second insulating member interposed between the peripheral edge portion and the first metal member.
      <8>

The battery according to <6> or <7>, in which the second metal member electrically connects the first metal member with the battery element in a normal state.

<9>

The battery according to any one of <6> to <8>, in which at an abnormally high temperature, the central portion of the second metal member is separated from the outer peripheral portion, the first metal member is displaced, and electrical connection between the first metal member and the outer peripheral portion of the second metal member is interrupted.

<10>

The battery according to any one of <6> to <9>, in which
the first metal member includes an outer peripheral part extending to an outer side with respect to the second metal member in a radial direction of the battery axis, and
the support portion is superposed on the outer peripheral part in a battery axis direction with the first insulating member interposed between the support portion and the outer peripheral portion.
   <11>

The battery according to any one of <6> to <10>, in which
each of the safety valves disposed at both the end portions further includes:
   a second metal member that is provided on an inner surface side of the first metal member and electrically connected to the first metal member; and
   a second insulating member that connects the first metal member and a peripheral edge of the second metal member and contains a thermosetting resin,
the first metal member has a first groove portion on an inner side in a radial direction perpendicular to a battery axis corresponding to a rotation axis of the cylindrical battery, with respect to a connection portion between the first metal member and the peripheral edge of the second metal member, and
the second metal member has a central portion electrically connected to the first metal member, a second groove portion, and an outer peripheral portion surrounding the central portion with the second groove portion interposed between the outer peripheral portion and the central portion.

### EXAMPLES

Hereinafter, the present disclosure will be described more specifically with reference to Examples according to an embodiment.

### Example 1

### [1. Preparation of Test Battery]

A secondary battery having the following specifications was prepared. The configuration of Example 1 is summarized in Table 1.
Shape: cylindrical shape (diameter: about 22 cm, axial length: about 70 mm)
Positive electrode and negative electrode of electrode assembly: positive electrode and negative electrode capable of occluding and releasing lithium ions
Nominal capacity: about 4100 mAh
Nominal voltage: 3.6 V
Both end portions: three-piece structure constituted of first metal member, support portion, and first insulating member (hereinafter also referred to as “heat release mechanism”) (Material of each member)
Safety cover (first metal member): made of metal (metal containing aluminum)
First insulating member: made of thermoplastic resin (polypropylene (PP))
Exterior body and support portion: made of metal (metal containing aluminum)

TABLE 1

| | Upper portion | | Lower portion | | | | |
|---|---|---|---|---|---|---|---|
| | | Presence | | Presence | | | |
| | Presence | or absence | Presence | or absence | | Evaluation | |
| | or absence | and material | or absence | and material | Arrangement | UL | Assumed |
| | and type | of first | and type | of first | of first | Projectile | mode of |
| | of safety | insulating | of safety | insulating | insulating | test | Projectile |
| | mechanism | member | mechanism | member | member | (1642) | test |
| Example 1 | Heat | PP | Heat | PP | Both end | Pass | 3 |
| | release | | release | | portions | | |
| | mechanism | | mechanism | | | | |
| Example 2 | Heat | PPS | Heat | PP | Both end | Pass | 3 |
| | release | | release | | portions | | |
| | mechanism | | mechanism | | | | |
| Example 3 | Heat | PP | Heat | PPS | Both end | Pass | 3 |
| | release | | release | | portions | | |
| | mechanism | | mechanism | | | | |
| Example 4 | Heat | PPS | Heat | PPS | Both end | Pass | 3 |
| | release | | release | | portions | | |
| | mechanism | | mechanism | | | | |
| Example 5 | Heat | PP | Heat | PP | Both end | Pass | 3 |
| | release | | release | | portions | | |
| | mechanism + | | mechanism | | | | |
| | first | | | | | | |
| | metal | | | | | | |
| | member | | | | | | |
| | cleavage | | | | | | |
| | mechanism | | | | | | |
| Comparative | First | — | — | — | — | NG | NG |
| Example 1 | metal | | | | | | |
| | member | | | | | | |
| | cleavage | | | | | | |
| | mechanism | | | | | | |
| Comparative | First | — | Stamping | — | — | Pass | 1 |
| Example 2 | metal | | mechanism | | | | |
| | member | | | | | | |
| | cleavage | | | | | | |
| | mechanism | | | | | | |
| Comparative | First | — | First | — | — | Pass | 1 |
| Example 3 | metal | | metal | | | | |
| | member | | member | | | | |
| | cleavage | | cleavage | | | | |
| | mechanism | | mechanism | | | | |
| Comparative | First | — | Heat | PP | One end | Pass | 2 |
| Example 4 | metal | | release | | portion | | |
| | member | | mechanism | | | | |
| | cleavage | | | | | | |
| | mechanism | | | | | | |
| Comparative | Heat | PP | — | — | One end | NG | NG |
| Example 5 | release | | | | portion | | |
| | mechanism | | | | | | |
| Comparative | Heat | PP | Stamping | — | One end | Pass | 2 |
| Example 6 | release | | mechanism | | portion | | |
| | mechanism | | | | | | |

PP: polypropylene;
PPS: polyphenylene sulfide;
heat release mechanism*: heat release mechanism without first insulating member;
“—”: absent

### [2. Safety Test]

### (2-1. UL Projectile Test (Burner Test))

A UL Projectile test (burner test) conforming to the UL1642 standard was carried out.

Specifically, the prepared battery of Example 1 was fully charged. The fully charged battery was fixed on a heating table with a wire. The periphery of the fixed battery was covered with an octagonal 17-mesh aluminum net. In this state, the battery was heated with a burner from below a heating table, and heating was continued until the battery was ignited or ruptured. The temperature of the burner flame was 700 to 740° C. The state of the ignited or ruptured battery was visually observed.

Based on the observation results, the safety of the battery of Example 1 was evaluated according to the following evaluation criteria. The evaluation results of the safety are summarized in Table 1.

### [Evaluation Criteria]

Pass (pass: good): Members of the ignited or ruptured battery have come out of the 17-mesh aluminum net
NG (fail: bad): Member of the ignited or ruptured battery have not come out of the 17-mesh aluminum net

### (2-2. Change in Internal Pressure of Battery in Abnormally High Temperature State)

For the examples in which the result of “2-1 UL Projectile test” described above was “Pass”, the change with time in the internal pressure of the battery in the abnormally high temperature state of the battery was further considered. This will be described with reference to Table 1 and FIG. 8. FIG. 8 is a diagram schematically showing a temporal change in internal pressure in the batteries of Examples and Comparative Examples.

In FIG. 8, the vertical axis represents the internal pressure of the battery (cell internal pressure), and the horizontal axis represents time. It is assumed that thermal runaway occurs between times T₁ and T₂. That is, the time T₁ indicates the thermal runaway start time, and the time T₂ indicates the time when the thermal runaway has ended.

On the other hand, the pressures aligned with P₁, P₂, P₃, and P₄ in ascending order from the closest to 0 (zero) on the vertical axis are P₁ (first insulating member release pressure) of the heat release mechanism, P₂ (safety valve cleavage pressure) of the first metal member cleavage mechanism, P₃ (can bottom stamping cleavage pressure) of the stamping mechanism, and P₄ (welded portion open withstanding pressure or crimp open withstanding pressure), respectively. Note that one among the heat release mechanism, the heat release mechanism+the first metal member cleavage mechanism, the first metal member cleavage mechanism, the stamping mechanism, and the absence of the safety mechanism was employed at the end portions of the batteries used in Example 1 and Examples 2 to 5 and Comparative Examples 1 to 6 described later.

In the battery of Comparative Example 2, it is considered that the internal pressure changes as indicated by Mode 1 (in FIG. 8, indicated by the continuous line). Specifically, in the battery of Comparative Example 2, the first metal member cleavage mechanism was employed at the end portion on the upper portion side, and the stamping mechanism was employed at the end portion on the lower portion side. Therefore, when the battery of Comparative Example 2 is brought into an abnormally high temperature state, gas is generated inside and thus the internal pressure gradually increases as the time changes from 0 to T₁. In Comparative Example 2, since the heat release mechanism is not employed, the internal pressure does not decrease at P₁. When the internal pressure further increases and reaches P₂, the first metal member cleavage mechanism operates. That is, the central portion of the second metal member is separated, and the first metal member is deformed and cleaved, so that the internal pressure decreases. Then, as the time increases from T₁ to T₂, the internal pressure further increases to reach P₃, so that the stamping mechanism operates and the internal pressure slightly decreases. Subsequently, the internal pressure reaches P₄.

In the battery of Comparative Example 3, it is considered that the internal pressure changes substantially as indicated by Mode 1 (in FIG. 8, indicated by the continuous line). Specifically, in the battery of Comparative Example 3, the first metal member cleavage mechanism was employed at the end portion on the upper portion side and the end portion on the lower portion side. For this reason, the first metal member cleavage mechanisms at both end portions operate at P₂, and thus it is considered that the internal pressure greatly decrease as compared with Mode 1 of FIG. 8. On the other hand, since the stamping mechanism does not operate at P₃, the internal pressure does not decrease. As a result, similarly to Comparative Example 2, it is considered that the internal pressure reaches P₄ early.

In the battery of Comparative Example 6, it is considered that the internal pressure changes as indicated by Mode 2 (in FIG. 8, indicated by the dashed line). Specifically, in the battery of Comparative Example 6, the heat release mechanism was employed at the end portion on the upper portion side, and the stamping mechanism was employed at the end portion on the lower portion side. Therefore, when the battery of Comparative Example 6 is brought into an abnormally high temperature state, gas is generated inside and thus the internal pressure gradually increases as the time changes from 0 to T₁. When the internal pressure reaches P₁, the heat release mechanism operates, that is, the thermoplastic resin of the first insulating member is softened to form a gas discharge path, so that the internal pressure decreases. As the time increases from T₁ to T₂, the internal pressure gradually increases. Since there is no current interrupt mechanism in Comparative Example 2, the internal pressure passes P₂ and reaches P₃. When the internal pressure reaches P₃, the stamping mechanism operates, so that the internal pressure slightly decreases. Subsequently, the internal pressure reaches P₄. Mode 2 is common to mode 1 in that the internal pressure reaches P₄, but it takes more time to reach P₄, and the internal pressure increases relatively slowly.

In the battery of Comparative Example 4, it is considered that the internal pressure changes substantially as indicated by Mode 2 (in FIG. 8, indicated by the dashed line). Specifically, in the battery of Comparative Example 4, the first metal member cleavage mechanism was employed at the end portion on the upper portion side, and the heat release mechanism was employed at the end portion on the lower portion side. For this reason, the first metal member cleavage mechanism operates at P₂, and thus it is considered that the internal pressure decreases at P₂ as compared with Mode 2 of FIG. 8. On the other hand, since the stamping mechanism does not operate at P₃, the internal pressure does not decrease. As a result, similarly to Comparative Example 6, it is considered that the internal pressure reaches P₄ with a delay.

In the batteries of Examples 1 to 4, it is considered that the internal pressure changes as indicated by Mode 3 (in FIG. 8, indicated by the long dashed short dashed line). Specifically, in each of the batteries of Examples 1 to 4, the heat release mechanism was adopted at the end portion on the upper portion side and the end portion on the lower portion side. Therefore, when the batteries of Examples 1 to 4 are brought into an abnormally high temperature state, gas is generated inside and thus the internal pressure gradually increases as the time changes from 0 to T₁. When the internal pressure reaches P₁, the heat release mechanism operates, so that the internal pressure decreases. As the time increases from T₁ to T₂, the internal pressure gradually increases. However, since the internal pressure is greatly reduced by the heat release mechanism, the internal pressure does not reach P₄. The internal pressure increases more slowly relative to Modes 1 and 2.

In the battery of Example 5, it is considered that the internal pressure changes substantially as indicated by Mode 3 (in FIG. 8, indicated by the long dashed short dashed line). Specifically, in the battery of Example 5, the heat release mechanism and the first metal member cleavage mechanism were employed at the end portion on the upper portion side, and the heat release mechanism was employed at the end portion on the lower portion side. Therefore, in addition to the decrease in the internal pressure due to the heat release mechanism at P₁, the first metal member cleavage mechanism operates at P₂, and thus it is considered that the internal pressure further decreases at P₂ as compared with Mode 3 of FIG. 8. As a result, similarly to Examples 1 to 4, the internal pressure increases relatively slowly.

Based on the matters described above, the safety of Example 1 was further evaluated according to the following evaluation criteria. The evaluation results are summarized in Table 1. Mode 3 was regarded as pass, and NG and Modes 1 and 2 were regarded as fail.

### [Evaluation Criteria]

Mode 3 (good): The internal pressure does not reach P₄ in a time equal to or longer than T₁ and equal to or shorter than T₂

Mode 2 (slightly bad): The internal pressure reaches P₄ in a time equal to or longer than (T₁+T₂)/2 and equal to or shorter than T₂

Mode 1 (bad): The internal pressure reaches P₄ in a time equal to or longer than T₁ and equal to or shorter than (T₁+T₂)/2

NG (very bad): The result of 2-1 US Projectile test is NG

### Examples 2 to 5 and Comparative Examples 1 to 6

### [1. Preparation of Test Battery]

Test batteries were prepared in the same manner as in Example 1 except that the battery configuration was changed to the configuration shown in Table 1. Specifically, the first metal member cleavage mechanism employed in Example 5 and so on was a combination of the heat release mechanism of Example 1 with the top cover, the second insulating member, and the stripper disk. That is, the first metal member cleavage mechanism had a valve configuration in which the top cover, the safety cover (the first metal member), the second insulating member, and the stripper disk are combined in this order.

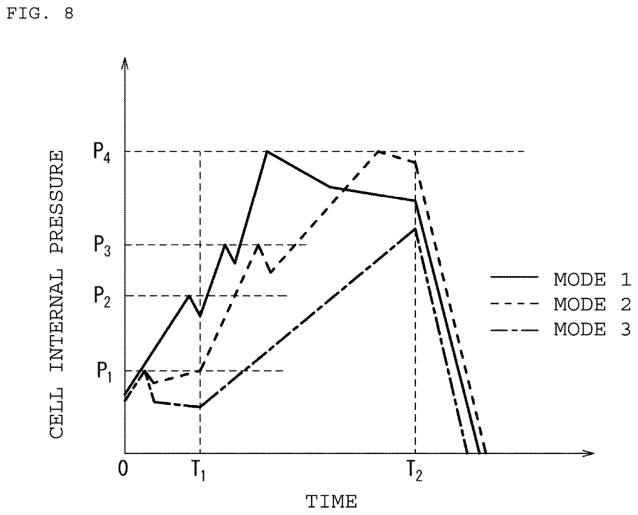

The stamping mechanism employed in Comparative Example 2 and so on will be described with reference to FIG. 7. FIG. 7 is a plan view schematically illustrating the end portion on the lower portion side of a comparative example. As illustrated in FIG. 7, the stamping mechanism has a C-shaped stamping portion at the end portion on the lower portion side. The stamping portion is relatively thinned. In addition, when gas is generated inside the battery in an abnormally high temperature state, the stamping portion may be broken to serve as a gas discharge path. However, the stamping mechanism is weak against external stress such as impact in falling, for example, and there is a risk of deteriorating safety in a normal state.

In addition, “-” in the column of “presence or absence and type of safety mechanism” at the end portion on the lower portion side of Comparative Examples 1 and 5 indicates that the safety mechanism is not employed. In this case, the first metal member, the support portion, and the exterior body were connected by welding.

### (Material of Each Member)

Second insulating member: made of resin (resin including PBT/polybutylene terephthalate resin)
Stripper disk: made of metal (metal containing aluminum)
First insulating member: made of thermoplastic resin (polypropylene (PP) or polyphenylene sulfide (PPS))

### [2. Evaluation]

For the batteries of Examples 2 to 5 and Comparative Examples 1 to 6, the safety test was performed in the same manner as in Example 1. Table 1 shows the evaluation results.

### Results: Examples 1 to 5 and Comparative Examples 1 to 6

As shown in Table 1, in the batteries of Examples 1 to 5, both the two end portions included the first metal member, the support portion, and the first insulating member. In all the batteries of Examples 1 to 5, the result of the UL Projectile test was Pass, and the assumed mode of the Projectile test was Mode 3.

As shown in Table 1, in the batteries of Comparative Examples 1 to 6, neither of the two end portions included the first metal member, the support portion, and the first insulating member. Specifically, the batteries of Comparative Examples 1 to 4 did not include the first insulating member at the end portion of the upper portion, and the batteries of Comparative Examples 1 to 3, 5 and 6 did not include the first insulating member at end portion of the lower portion.

In addition, the batteries of Comparative Examples 1 to 6 satisfied neither the condition that the result of the UL Projectile test was Pass and the condition that the assumed mode of the Projectile test was Mode 3. Specifically, in the batteries of Comparative Examples 1 and 5, the result of the UL Projectile test was NG. In the batteries of Comparative Examples 1 and 5, the assumed mode of the Projectile test was NG, and in the batteries of Comparative Examples 2 to 4 and 6, the assumed mode of the Projectile test was Mode 1 or Mode 2.

From the above, it is apparent that Examples 1 to 5, which are included in the scope of the invention according to claim 1, are superior in safety to Comparative Examples 1 to 6, which are out of the scope of the invention according to claim 1.

Note that the effects and the like of the above Examples are merely an example. Therefore, the present disclosure is not limited to the above matters, and may have additional effects.

The battery according to the present disclosure (a battery such as a primary battery and a secondary battery) can be typically used for applications in which use of electric energy is required. For example, the (secondary) battery according to the present disclosure can be used in various fields in which power storage is assumed. Although it is merely an example, the (secondary) battery of the present disclosure can be used in the fields of electricity, information, and communication in which electric and electronic equipment and the like are used (for example, electric and electronic equipment fields or mobile equipment fields including mobile phones, smartphones, notebook computers and digital cameras, activity meters, arm computers, electronic papers, and wearable devices, and small electronic machines such as RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (for example, the fields of hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery that is a cylindrical battery comprising:
a cylindrical exterior body that houses a battery element; and
safety valves disposed at both end portions of the exterior body, wherein
each of the safety valves includes:
a first metal member;
a support portion that is provided to support the first metal member at a peripheral edge portion of the first metal member and has an opening; and
a first insulating member that connects the first metal member and the support portion and contains a thermoplastic resin.

2. The battery according to claim 1, wherein the thermoplastic resin includes at least one resin selected from the group consisting of a super engineering plastic-based resin and a polyolefin-based resin.

3. The battery according to claim 1, wherein in a normal state, the first insulating member seals between the metal member and the support portion.

4. The battery according to claim 1, wherein in an abnormally high temperature state, the thermoplastic resin is softened to form a gas discharge path that makes an inside of the battery and an outside of the battery communicate with each other.

5. The battery according to claim 1, wherein an outer surface of the exterior body has a structure not including a beading part.

6. The battery according to claim 1, wherein
at least one of the safety valves disposed at both the end portions further includes:
a second metal member that is provided on an inner surface side of the first metal member and electrically connected to the first metal member; and
a second insulating member that connects the first metal member and a peripheral edge of the second metal member and contains a thermosetting resin,
the first metal member has a first groove portion on an inner side in a radial direction perpendicular to a battery axis corresponding to a rotation axis of the cylindrical battery, with respect to a connection portion between the first metal member and the peripheral edge of the second metal member, and
the second metal member has a central portion electrically connected to the first metal member, a second groove portion, and an outer peripheral portion surrounding the central portion with the second groove portion interposed between the outer peripheral portion and the central portion.

7. The battery according to claim 6, wherein
the second metal member is disposed in the opening of the support portion, and
the second metal member includes:
a protruding portion that is disposed at a center, protrudes relatively outward with respect to a battery axis, and is electrically connected to the first metal member; and
a peripheral edge portion that is disposed on a peripheral edge of the protruding portion and is connected to the first metal member with the second insulating member interposed between the peripheral edge portion and the first metal member.

8. The battery according to claim 6, wherein the second metal member electrically connects the first metal member with the battery element in a normal state.

9. The battery according to claim 8, wherein at an abnormally high temperature, the central portion of the second metal member is separated from the outer peripheral portion, the first metal member is displaced, and electrical connection between the first metal member and the outer peripheral portion of the second metal member is interrupted.

10. The battery according to claim 6, wherein
the first metal member includes an outer peripheral part extending to an outer side with respect to the second metal member in a radial direction of the battery axis, and
the support portion is superposed on the outer peripheral part in a battery axis direction with the first insulating member interposed between the support portion and the outer peripheral portion.

11. The battery according to claim 6, wherein
each of the safety valves disposed at both the end portions further includes:
a second metal member that is provided on an inner surface side of the first metal member and electrically connected to the first metal member; and
a second insulating member that connects the first metal member and a peripheral edge of the second metal member and contains a thermosetting resin,
the first metal member has a first groove portion on an inner side in a radial direction perpendicular to a battery axis corresponding to a rotation axis of the cylindrical battery, with respect to a connection portion between the first metal member and the peripheral edge of the second metal member, and
the second metal member has a central portion electrically connected to the first metal member, a second groove portion, and an outer peripheral portion surrounding the central portion with the second groove portion interposed between the outer peripheral portion and the central portion.
